(19) United States
(12) Patent Application Publication
(10) Pub. No.: US 2002/0197396 A1
(43) Pub. Date: Dec. 26, 2002

(54) Treated yarn and methods for making same

(76) Inventor: Gregory W. Haggquist, Longmont, CO (US)

Correspondence Address: FISH & NEAVE, 1251 AVENUE OF THE AMERICAS, 50TH FLOOR, NEW YORK, NY, 10020-1105, US

(21) Appl. No.: 10/184,132

(22) Filed: Jun. 26, 2002

Related U.S. Application Data
(60) Provisional application No. 60/301,099, filed on Jun. 26, 2001.

(51) Int. Cl. B05D 3/02; B05D 1/28

(52) U.S. Cl. 427/180; 427/385.5; 427/428; 427/553; 118/308

(57) ABSTRACT

The present invention relates to methods and apparatuses for treating yarn to enhance the performance characteristics, such as the odor adsorption capacity, of the yarn while retaining the physical properties, such as hand and feel, associated with the yarn. Methods for treating the yarn involve incorporating solid particles such as activated carbon into the yarn using an air dispersion technique or a padding technique. The air dispersion technique disperses the solid particles over the yarn in a controlled air stream. The padding technique incorporates solid particles into the yarn when the yarn passes through a bath of solid particles. The yarn treating method may apply a binding agent to the yarn. The binding agent binds the solid particles to the yarn without inhibiting the performance characteristics of the solid particles. The yarn treating method further includes curing the binding agent to permanently attach the solid particles to the yarn.

### CROSS-REFERENCE TO A RELATED PATENT APPLICATION

This application claims the benefit of U.S. Provisional Application No. 60/301,099, filed Jun. 26, 2001, the disclosure of which is hereby incorporated by reference in its entirety.

### TECHNICAL FIELD OF THE INVENTION

The present invention relates to fibers and yarns that are coated with solid particles. The present invention also relates to processes for coating the surface of fibers and yarns with solid particles. The solid particles add performance characteristics to the fibers and yarns, including odor adsorption, moisture management and/or ultraviolet light protection.

### BACKGROUND OF THE INVENTION

It is well known that various materials such as fabrics, clothing, and other apparel can be treated to enhance the performance characteristics associated with the material. The performance characteristics can include, for example, odor adsorption, moisture control, ultra-violet light protection, and/or protection from external elements. Sportswear fabrics such as CoolMaX™, HydroMove™, Dry-Fit™, and Dry-Tech™ are examples of fabrics that manage moisture and/or add ultra-violet light protection. Other examples of performance enhanced apparel includes odor adsorbing hunting suits. Such hunting suits may adsorb odors (e.g., caused by perspiration) and allows a hunter to approach wild game without the hunter's scent being detected. Military apparel made from a high performance fabric may protect soldiers from chemical and biological weapons.

Certain materials naturally exhibit certain performance characteristics without being treated with chemicals or additives. For example, apparel constructed from an untreated material such as Lycra™ exhibits a moisture management characteristic. Materials such as Lycra™, however, may not exhibit any other characteristics such as odor adsorption and/or ultra-violet protection. In addition, apparel constructed from untreated materials are limited to the physical properties (e.g., texture, feel, durability, etc.) associated with that untreated material. Moreover, the performance characteristics of such materials are often limited and do not adequately enhance the material.

The materials used for producing the above-mentioned apparel may be enhanced using a variety of different methods. For example, one method can include applying chemicals such as Scotchgard™ to impart the desired performance characteristics on the material. After the chemicals are applied, however, the chemicals often dissipate and have to be reapplied continuously throughout the life of the fabric to impart the desired characteristics. The chemicals may dissipate, for example, when the treated fabric is washed or exposed to external elements.

It is therefore desirable to produce a high performance fabric that has desirable physical properties such as texture and durability, provides superior performance characteristics, and retains those performance characteristics after repeated use. Such a high performance fabric can be produced by treating the yarn or fiber prior to using the yarn or fiber to produce the desired material.

Approaches have been attempted to bind solid particles such as activated carbon to yarn prior to producing a fabric. Activated carbon is a granular substance that varies in size and shape depending on the process used to create the activated carbon. The activated carbon's surface area is covered with pores that also vary in size and shape depending on how it is produced. These pores provide the activated carbon with properties such as odor adsorption.

One approach involves incasing a layer of activated carbon between two layers of fabric. This technique, however, yields an odor adsorbing fabric that is heavy and cumbersome for a person to wear. Another approach that has been attempted is to incorporate the active carbon into a sheathing layer that surrounds the yarn. This approach, however, alters the physical property of yarn. Thus none of the known methods sufficiently improve upon yarns such as natural (e.g., cotton or wool) yarn or synthetic yarn (e.g., polymer).

Other approaches have addressed the problem of solid particle deactivation when attempting to permanently bind the solid particles to the yarn. Solid particles such as activated carbon should remain active to provide the desired performance. The known approaches, however, typically overload the yarn with solid particles to compensate for deactivation. Overloading the yarn substantially alters the material property (e.g., color, hand and feel, texture, durability, etc.) of the yarn because the yarn's properties are heavily biased by the solid particles.

It is therefore an object of the present invention to permanently attach solid particles to the porous structure of a yarn or fiber.

It is also an object of the present invention to use a minimal quantity of solid particles to impart the desired performance characteristics while retaining the physical properties of the yarn or fiber.

### SUMMARY OF THE INVENTION

These and other objects of the present invention are accomplished in accordance with the principles of the present invention by providing yarn treating methods and apparatuses for incorporating and permanently attaching solid particles to a porous yarn. The solid particles enhance the performance characteristics associated with the yarn while preserving the properties of the yarn. The solid particles can impart performance characteristics such as trapping odors, moving moisture, trapping chemical agents, providing ultra-violet light protection, and protection from other elements. The solid particles can also provide enhanced wicking properties, chemo-protective properties, fire retardance, antibacterial, antiviral, antifungal, and/or antimicrobial characteristics. The properties of yarn can include hand and feel, texture, color, and durability.

The solid particles are embedded in the yarn at a predetermined concentration such that the material properties of the yarn are preserved while simultaneously enhancing the performance characteristics of the yarn. In one embodiment of the present invention, the treated yarn may have about 1% to about 70% solid particle incorporation by weight compared to the weight of the yarn. In a more preferable embodiment of the present invention, the treated yarn may have about 5% to about 15% solid particle incorporation by weight.

The yarn treating process can treat yarn by using the following steps: 1) subjecting yarn to solid particle deposition; 2) applying a binding agent to the yarn array; and 3) curing the binding agent to permanently attach the solid particles to the yarn. If desired, the yarn treating process can be implemented by applying the binding agent first and then subjecting the yarn to solid particle deposition. Then the yarn is subjected to the curing step. In another approach, the yarn treating process can be implemented by subjecting the yarn to solid particle deposition and then binding the solid particles to the yarn without using a binding agent.

The solid deposition step can be performed using an air dispersion method or a padding method. The air dispersion method involves dispersing the solid particles in an air stream over the yarn as the yarn passes through the air dispersion chamber. The air dispersion chamber can control the level of solid particle incorporation by varying the intensity and direction of the airflow within the chamber.

The padding method involves passing yarn through a bath of solid particles. As the yarn passes through the bath, the solid particles adhere to the yarn. The padding process can agitate the solid particle bath to prevent formation of channels that could prevent adequate solid particle incorporation. In addition, the padding method can pad the yarn with solid particles with a roller as it passes through the padding chamber.

The binding application step involves applying a solution comprising the binding agent to the porous yarn. A predetermined concentration of the binding agent is contained within the solution to effectively bind the solid particles to the yarn without encapsulating the solid particles. Encapsulation of solid particles can prevent the solid particles from imparting their desired performance characteristics onto the yarn. The binding agent can be applied by subjecting the yarn to a bath of the solution. In another approach, a roller can apply the solution as it passes through a binder application station.

The curing step involves curing the biding agent to permanently attach the solid particles to the yarn. Curing can be performed by passing the yarn through an oven such as heat convection oven or an electric oven which causes the binding agent to cure. In another approach, the yarn may be subjected to irradiation such as infrared radiation, ultra-violet radiation, or any other suitable type of radiation to effect curing. In yet another approach, curing may be performed by blowing air over the yarn.

In another embodiment, curing may be used to bond the solid particles to the yarn on a molecular level. For example, if a synthetic yarn such as a nylon is used, an irradiation source may heat the nylon above its glass transition temperature. When the nylon is above the glass transition temperature, portions of the solid particles embed within the nylon yarn. After the nylon cools, the solid particles are permanently embedded in the yarn.

The present invention also provides a system to implement the above-described processes. The system may include several features commonly associated with yarn processing machines (e.g., slashing machines) but also includes a solid particle deposition chamber such as an air dispersion chamber or padding chamber. The system may include a binder application station and a curing station. The computer may, for example, control the speed in which the yarn passes through the system. The computer may control, for example, the air flow control system of an air dispersion device. The computer may receive data monitored by various sensors positioned strategically throughout the system. Various software programs may be implemented on the computer that allow a user to program different yarn treating processes according to, for example, different types of yarn or solid particles being used for a process.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a three-dimensional view of a section of porous yarn having solid particles incorporated therein in accordance with the principles of the present invention;

FIG. 2 shows a flowchart of a process for treating yarn in accordance with the principles of the present invention;

FIG. 3 shows a flowchart of a different process for treating yarn in accordance with the principles of the present invention;

FIG. 4 shows a flowchart of yet another process for treating yarn in accordance with the principles of the present invention;

FIG. 5 shows a cross-sectional view of an air dispersion device for incorporating solid particles into yarn in accordance with the principles of the present invention;

FIG. 6 shows a top-view of an air-flow control system for the air dispersion device of FIG. 5 which is in accordance with the principles of the present invention;

FIG. 7 shows a detailed cross-sectional view of the air-flow control system taken along the lines 7-7 of FIG. 6 in accordance with the principles of the present invention;

FIG. 8 shows a partial cross-sectional view of a suction box of the air dispersion device of FIG. 5 in accordance with the principles of the present invention;

FIG. 9 shows a detailed cross-sectional view of the suction box taken along circle 9 of FIG. 8 in accordance with the principles of the present invention;

FIG. 10 shows a side view of an air dispersion device of FIG. 5 in accordance with the principles of the present invention;

FIG. 11 shows another air dispersion device for incorporating solid particles into yarn in accordance with the principles of the present invention;

FIG. 12 shows several illustrative yarn incorporation devices for padding solid particles into the yarn in accordance with the principles of the present invention;

FIG. 13 shows a three-dimensional view of a padding device that pads solid particles into several yarns in accordance with the principles of the present invention;

FIG. 14 shows a cross-sectional view of the padding device taken along the lines 14-14 of FIG. 13 in accordance with the principles of the present invention;

FIG. 15 shows an illustrative binder application device for applying a binding agent to the yarn in accordance with the principles of the present invention;

FIG. 16 shows an illustrative yarn flow path through a curing station in accordance with the principles of the present invention; and

FIG. 17 shows an illustrative yarn treating system that is in accordance with the principles of the present invention.

### DETAILED DESCRIPTION OF THE INVENTION

This invention relates to yarns that are coated with solid particles. In addition, this invention relates to various processes for coating yarn with solid particles.

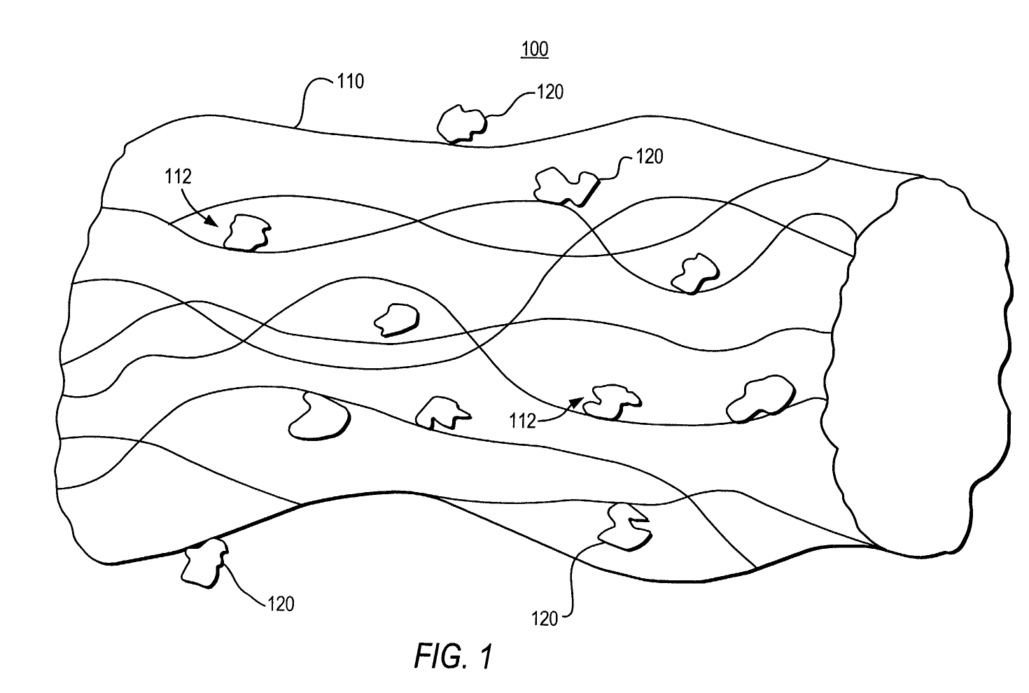

FIG. 1 shows treated yarn 100 that is in accordance with the principles of the present invention. Treated yarn 100 includes porous yarn 110 and solid particles 120 (e.g., activated carbon). A porous yarn may be a yarn that includes several pores, gaps, depressions, ruts, etc. in which a solid particle can be deposited. As used herein, the term yarn refers to any continuous strand of material. Such a yarn may be formed from a single filament, or two or more plies, of natural or synthetic fibers. Other terms used to describe a material that may be coated using the processes of this invention include strand, fiber, filament, thread, and string. Persons skilled in the art will appreciate that yarns and related materials having a certain length are more practical for use in yarn treating processes of this invention. That is, it may be impractical to coat short yarns or fibers.

As shown in FIG. 1, solid particles 120 are contained in porous structures 112 and on the surface of porous yarn 110. The distribution of solid particles 120 throughout porous yarn 110 is preferably substantially uniform to maximize the surface area of solid particles 120 exposed to the ambient environment. More particularly, the distribution of solid particles 120 by weight per unit area of yarn 110 is substantially uniform throughout.

Persons skilled in the art will appreciate that solid particles 120 need not be uniformly distributed to achieve the desired characteristics (described below) provided by treated yarn 100. For example, solid particles 120 may be distributed disproportionately throughout porous yarn 110. That is, solid particles 120 may be concentrated more heavily in certain portions of porous yarn 110 than in others.

The solid particles include, but are not limited to, activated carbon, graphite, aluminum oxide (activated alumina), silica gel, soda ash, aluminum trihydrate, baking soda, p-methoxy-2-ethoxyethyl ester Cinnamic acid (cinoxate), zinc oxide, zealites, areogels, and titanium dioxide.

As defined herein, performance characteristics provided by the solid particles include, but are not limited to, trapping odors, moving moisture, trapping chemical agents, providing ultra-violet light protection, and protection from other elements. The solid particles can also provide enhanced wickability, chemo-protective properties, fire retardance, antibacterial, antiviral, antifungal, and/or antimicrobial characteristics.

The size of the solid particles used for treating yarn varies by available manufacturing processes. The size of the solid particles affects the texture (e.g., coarseness) of the treated yarn. Thus, when a yarn having small solid particles is embedded into a material, it may have a softer feel than a material woven from yarn treated with larger particles. Using smaller particles, however, typically results in higher material cost. In one embodiment of the present invention, the size of the solid particles may range from about 1 μm to about 200 μm. In a preferable embodiment, the size of the solid particles can range from about 0.1 μm to about 10 μm. In another embodiment, the solid particle size can range from about 1 μm to about 5 μm. Persons skilled in the art will appreciate that the size of the solid particles can vary from the above-described ranges. For example, as techniques and processes improve for producing smaller solid particles, it should noted that such smaller particles can be used in the present invention. For example, the solid particle size could range from about 10 nm to about 200 μm.

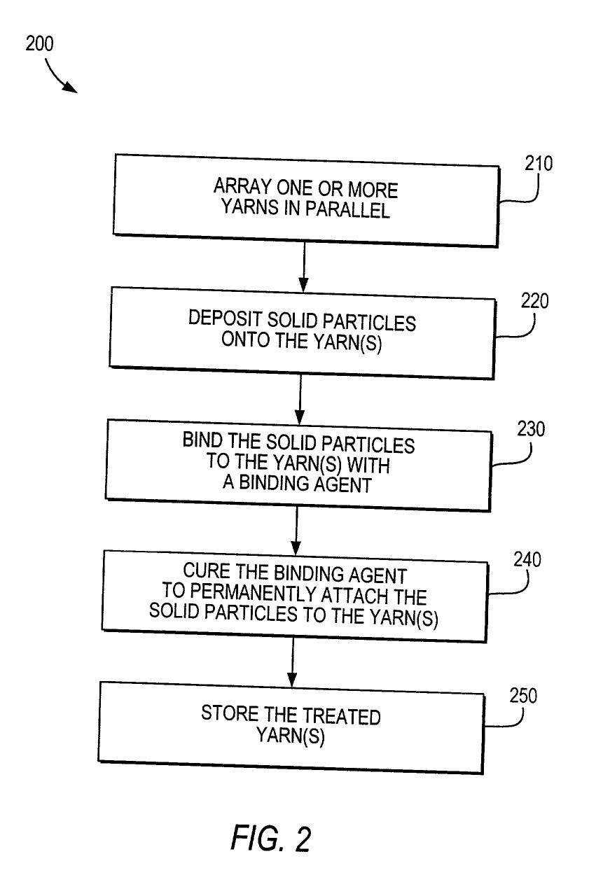

Some or all of solid particles 120 may be bound to porous yarn 110 with a binding agent (not shown). The binding agent 130 permanently “binds” solid particles 120 to porous yarn 110 without fully encapsulating every solid particle 120. If a solid particle is encapsulated (e.g., coated), that solid particle cannot provide its beneficial material characteristics. It should be noted, however, that a small percentage of solid particles 120 are inevitably fully coated by the binding agent. (The binding agent is described below in more detail with reference to FIG. 2.) But such negligible encapsulation does not hamper the performance of treated yarn 100. In accordance with this invention, the binding agent is attached to a portion of each solid particle, and through this connection, each solid particle 120 is permanently attached to yarn 110. Because a portion of each solid particle 120 is covered by the binding agent, the other uncovered portion is exposed to the surrounding environment, thus maximizing the performance of treated yarn 100.

One advantage of the present invention is that the treated yarn retains the properties (i.e., hand and feel of the yarn) while being enhanced with the performance characteristics of solid particles such as activated carbon. The treated yarn is able to retain the physical properties of the yarn because the loading of solid particles is such that the solid particles do not dominate the physical properties of the yarn. Loading is the percent weight of solid particles incorporated into the yarn compared to the total weight. Described in other terms, loading equals the weight of solid particles/the combined weight of the yarn and solid particles (% w/w).

Any suitable loading can be applied to the yarn for use in the present invention. For example, the present invention can provide solid particle loading ranging from about 1% w/w to about 100% w/w. If desired, the solid particle loading may exceed 50% w/w, resulting in applying concentrations of solid particles that exceeds the weight of the yarn itself. Preferably, however, the present invention provides loading that ranges from about 1% w/w to about 70% w/w. More preferably, the present invention provides loading that ranges from about 5% w/w to about 15% w/w.

A process for treating yarn, in accordance with the principles of the present invention, is shown as process 200 in FIG. 2. Beginning at step 210, yarn may be arrayed in parallel from one or more spools of yarn (to provide an array of yarns that are subjected to process 200). It is desirable to array one or more yarns prior to treatment because this increases the throughput of treated yarn and maximizes the economy of process 200. Several yarns can be aligned in parallel using a creel and a slasher. A creel is a device that can hold several spools of yarn and a slasher is a device that arrays the yarn (in parallel) as it is drawn from the spools.

After the yarn is arrayed at step 210, the yarn is subjected to solid particle deposition step 220. At step 220, solid particles (e.g., activated carbon) are deposited onto the yarn. Some solid particles are deposited and contained in the porous structure of the yarn, while other solid particles rest on the yarn's outer surface. One advantage of the present invention is that the solid particles are deposited into the yarn in a dry, activated state. Depositing the solid particles into the yarn in dry state preserves the activated nature of the solid particles. Mixing the activated solid particles with a binding agent prior to being deposited into a yarn typically reduces the activation of the particles, thus reducing the performance characteristics of the yarn. The present invention, however, preserves the activated nature of the solid particles and maximizes the performance characteristics of the yarn.

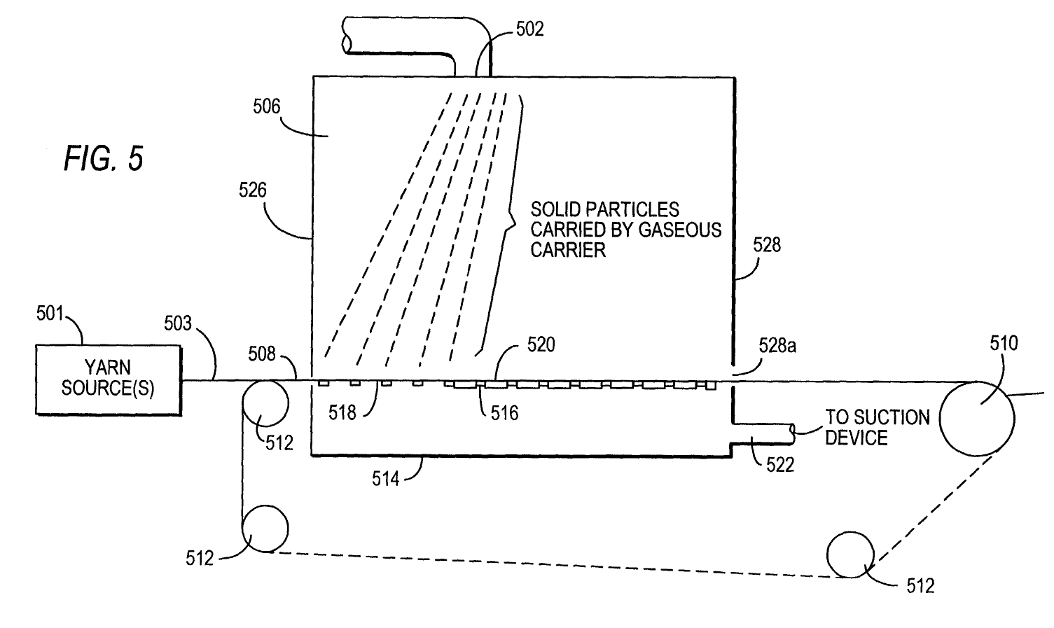

Deposition step 210 may be implemented using one of several methods. One method is an air dispersion method that provides a controlled pressure drop to disperse the solid particles in a carrier gas to coat the yarn. Another method is a padding method, which pads yarn with solid particles. The dispersion and padding methods are described in more detail in conjunction with the text accompanying FIGS. 5-11 and FIGS. 12-14, respectively. After the yarn is coated with solid particles, it proceeds to binder application step 230.

At binding application step 230, a binding agent is applied to bind the solid particles to the yarn. The binding agent may be any suitable substance such as, for example, a resin, a glue, an epoxy, a light activated epoxy, a tar, a cross-linking polymer, a thermoplastic polymer, polyurethane, polyacrylic, natural rubber latex, NEOPRENE, styrene butadiene, acrylic/acrylonitrile copolymer, modified n-butyl acrylonitrile copolymer, acrylonitrile polyvinyl acetate, polyacrylate, acrylonitrile butadiene, acrylic methyl methacrylate, self cross linking copolymers of vinyl acetate and ethylene, polystyrenes, polyesters, polyvinyl alcohol, polyvinyl acetate, vinyl chloride copolymers, melamine-formaldehyde resins, solutions of starch, carboxymethyl cellulose, methyl cellulose, sodium silicate, and siloxanes, siloxane based reactive polymer, including functionalized siloxanes, or combinations of the above (provided that each component of the combination is compatible with each other component).

A polyurethane binding agent may be used to improve the hand and the moisture management properties of the yarn. A polyurethane binding agent can be, for example a binding agent sold as Perapret N-U by the BASF corporation of Charlotte, N.C. An acrylic binding agent may be used to increase the binding strength of the solution. An acrylic binding agent can be, for example, a binding agent sold as Helizarin Binder HIT by the BASF corporation of Charlotte, N.C. If desired, a combination of binding agents can be applied to the yarn. For example, a polyurethane and an acrylic can be mixed together to provide a binding agent that has both moisture management properties and binding strength.

As described above in FIG. 1, the binding agent permanently attaches the solid particles to the yarn with minimal encapsulation. Encapsulation of the solid particles can prevent the solid particles from imparting the desired performance characteristics to the yarn. For example, if the solid particle is activated carbon, encapsulation can deactivate the activated carbon, thereby rending it ineffective in providing the desired performance characteristics. One technique used to minimize encapsulation is to mix the binding agent with water or another aqueous substance (e.g., water) to form a solution.

Application of a solution to the yarn provides a measure of control in the concentration of the binding agent used to bind the solid particles to the yarn. For example, water soluble binders include a mixture (e.g., concentration of binding agent and water) that can vary depending on the type of yarn, solid particles, deposition method, binding application, and/or curing step (discussed below) used in process 200. Therefore, it is desirable to properly dilute the solution (e.g., concentration of binding agent versus water) before applying it to the yarn. The strength of the solution can be varied to control binding efficiency of the solid particles to the yarn. Yet the strength can also be varied to minimize potential for solid particle encapsulation. For example, if the solution is too strong, application of the solution may result in undesired encapsulation. However, if the solution is too weak, there may not be enough binding agent to adequately bind the solid particles to the yarn. Therefore, it is desirable to use a solution that provides sufficient binding capacity and does not encapsulate an undesired proportion of the particles.

The concentration of the binding agent in the solution can vary from about 1% to about 100% of the total weight of the solution. Certain embodiments of the present invention can have binding agent concentrations ranging from about 1% to about 50%, from about 50% to about 99%, from about 30% to about 70%, from about 1% to about 30%, or from about 5% to about 15%.

Another advantage of using a solution is that the yarn may absorb (e.g., wick up) the solution more readily than the solid particles. The natural affinity yarn has for absorbing the solution is particularly useful because it minimizes potential encapsulation of solid particles. For example, assume that the solution is applied to a particular section of yarn. This particular section absorbs the solution and transmits the solution to solid particles that are attached to that particular section and binds the solid particles to the yarn.

In another approach, the solution may have an excess of air pumped into it to form a foam that is applied to the yarn. Because foam is a viscous material, it can easily be applied to the yarn. Moreover, because foam comprises air pockets, the binding agent is in condition to cure more quickly than a binding agent contained within a solution.

Binding step 230 may occur substantially immediately after the solid particles are deposited in the yarn to minimize the quantity of solid particles that “fall” off the yarn between deposition step 220 and binding step 230. The substantially immediate application to binding step 230 maximizes retention of the solid particles initially deposited in the yarn. Maximizing retention of the solid particles is desired for providing optimal performance characteristics.

Controlling the application of the solution to the yarn also minimizes potential solid particle encapsulation. Various techniques may be implemented to control application of the solution to the yarn. For example, a spraying, padding, extruding, or rolling technique can be used to apply solution to the yarn. These techniques control the quantity of the solution applied to the yarn. If an excess binding agent is applied, it can be removed, for example, by suction, squeezing, or by some other process. Suction may be accomplished by applying a vacuum to pull the excess binding agent off the yarn. Excess binder may be squeezed off the yarn using a pair of rollers. The rollers, however, should be constantly cleaned so that they do not inadvertently apply additional binding agent to the yarn as it passes through the binding stop.

After the binding agent is applied, the treated yarn undergoes a curing process at step 240. The binding agent is cured to permanently attach the solid particles to the yarn. After the binding agent is applied to the yarn, prompt subjection to the curing is preferable to minimize potential solid encapsulation by the binding agent. If the yarn is subjected to the curing step immediately, the binding agent begins to set before it has an opportunity to deactivate the solid particles. Once cured, the treated yarn is in a condition suitable for being woven into materials such as, for example, socks, undergarments, outerwear, apparel, or other woven/knitted fabrics. In addition, the treated yarn can maintain its performance characteristics after being washed or subjected to other conditions.

Several different methods can be used to perform curing. The treated yarn may be passed through an oven that applies heat to cure the binding agent. Another method may include blowing air over the treated yarn to affect curing. Yet another method for curing involves irradiating the treated yarn with an infrared, ultraviolet, or other irradiation source. It should be noted that two or more curing methods can be used to perform the curing step. For example, the treated yarn may be subjected to irradiation, then be subjected to air drying. Persons skilled in the art will appreciate that curing methods other than those described above can be used to cure the binding agent.

The type of curing method used may be dependent upon on the binding agent used. For example, if the binding agent is a light activated adhesive, then such an adhesive requires light (e.g., infrared light) to effect curing. The curing method may depend on the type of yarn used. For example, if the yarn is a material that is susceptible to catching fire, then the yarn (e.g., a cotton yarn) may not be able to pass through a direct heat curing process.

At step 250, the treated yarn is stored. Persons skilled in the art will appreciate that yarn can be stored in any suitable manner. For example, yarn can be wrapped on a spool or a winder. In another example, the treated yarn may be applied directly to a weaving or knitting process.

Throughout process 200, it is desirable to pass the yarn through each step (e.g., deposition step 220, binding step 230, curing step 240) at a substantially continuous rate. This can be accomplished using a series of rollers, tension supports, or conveyor belts that transport the yarn through each of the steps. Because process 200 is a serial process (i.e., steps occur sequentially), process 200 is generally limited to the speed of the slowest step. Therefore, the time required by each step is preferably minimal.

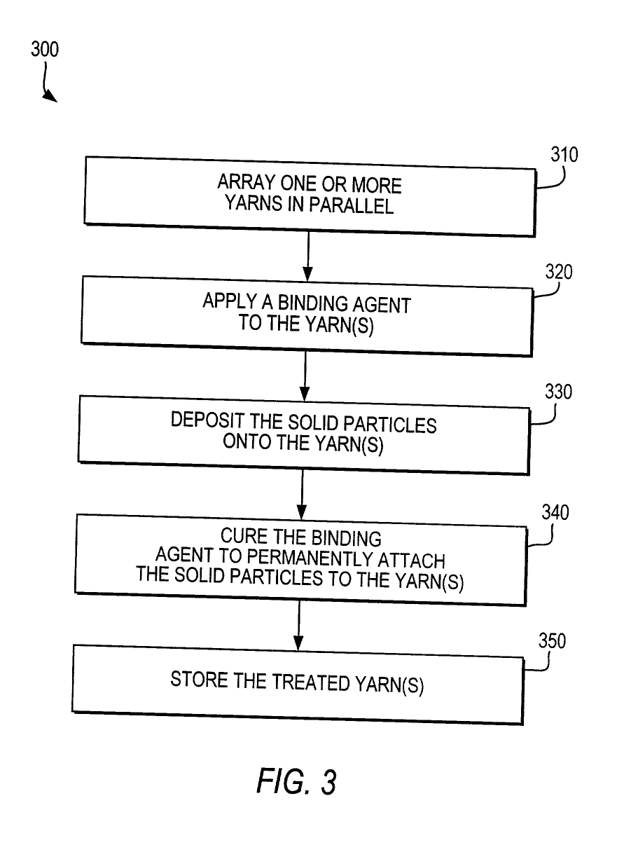

FIG. 3 illustrates an alternative process 300 that may be implemented to treat yarn in accordance with the principles of the present invention. Process 300 includes the same steps as process 200, but two steps are performed in a different sequence. Process 300 begins with step 310, which arrays one or more yarns in parallel prior to subjecting the yarn to step 320.

At step 320, a binding agent may be applied to the yarn. Similar to step 230 of FIG. 2, the binding agent can be included in a solution that is applied to the yarn. In step 320, the yarn wicks up a predetermined quantity of the solution before entering step 330. As described above in conjunction with binding step 230 in FIG. 2, the same principles of applying the binder and removal of excess binder applies to step 320.

At step 330, solid particles are deposited onto the yarn and are attached by the binder. Because the yarn is at least partially saturated with the solution, any solid particles that come in contact with the yarn is contained therein. After the solid particles are deposited and attached to the yarn by the binding agent, the binding agent is cured at curing step 340. Once cured, the treated yarn is stored at storing step 350. Steps 340 and 350 are similar to steps 240 and 250, respectively, of FIG. 2, and therefore do not need to be described in detail.

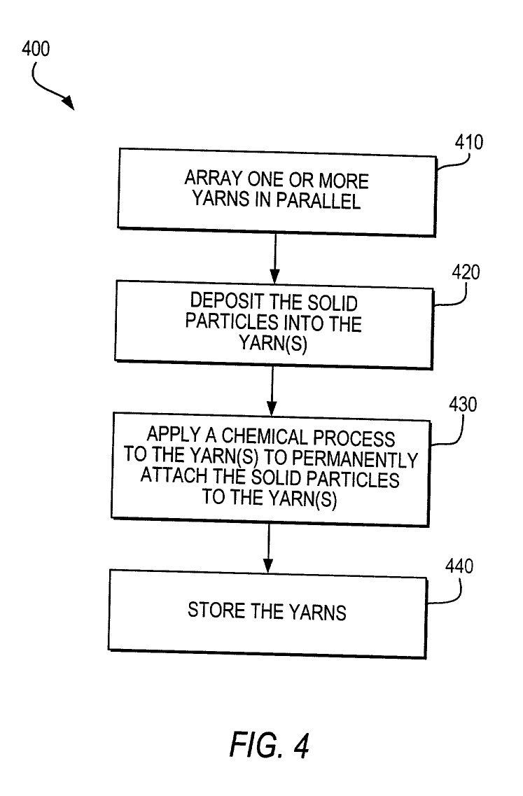

FIG. 4 illustrates yet another yarn treating process 400 that can be implemented in accordance with the principles of the present invention. Process 400 includes step 410, which arrays yarns in parallel to maximize utility of the apparatuses used for the invention. At step 420, solid particles are deposited on the yarn using, for example, a padding method, an air dispersion method, or any other suitable method. After the solid particles are deposited, the yarn is subjected to a curing process at step 430.

Process 400 does not use a binding application step such as step 230 or step 320 of FIGS. 2 and 3, respectively, but binds the solid particles to the yarn using only the curing step. As described above, curing may include, for example, irradiation. Irradiation may cause some of the yarn fibers to chemically bond to the solid particles. Using this approach, assume that the yarn is constructed from a synthetic material such as nylon. When the synthetic material is subjected to irradiation, the synthetic material is heated above its glass transition temperature, which causes the solid particles to embed into the yarn. After the yarn cools, the solid particles are permanently embedded in a portion of the yarn.

If, for example, the yarn is a natural material such as cotton, solid particles such as carbon can bond to the cotton via hydrogen bonding when subjected to heat in the curing step. The heat may cause the surface of the carbon and the cotton to form a chemical bond, thereby incorporating the solid particles into the yarn.

At step 450, the treated yarn is stored using any standard practice known to those of skill in the art. Thus it is seen that several different methods can be implemented to treat yarn. As briefly mentioned above, different apparatuses are used to perform different steps of the invention. Turning now to FIG. 5, an air dispersion device is shown for depositing solid particles into yarn.

Air dispersion device 500 can be used to provide an air dispersion process for incorporating solid particles into yarn according to the principles of the present invention. A process that can be implemented by air dispersion device 500 may include: entraining solid particles in a gaseous carrier; disposing a first face of a yarn or multiple yarns (e.g., an array of yarns) in the path of a stream of the gaseous carrier and entrained solid particles; maintaining a pressure drop across the yarn from the first face to a second face of the yarn, thereby incorporating into the yarn at least some of the entrained particulate solid in the gaseous carrier; and fixing the incorporated solid particles on and/or in the yarn.

For purposes of brevity and clarity, it will be understood that one or more yarns can be subjected to a solid particle incorporation method such as air dispersion and padding, but the discussion will be primarily described with reference to one strand of yarn.

The distribution of the pressure drop across the yarn dictates the uniformity of solid particle incorporation into the yarn. The uniformity of incorporation may be controlled by altering the pressure distribution across the width and the length of the yarn. There are many methods of altering the pressure distribution across the yarn. For example, slats may be used to dampen air flow. This allows a fine degree of control over the directional flow of entrained solid particles through the yarn, resulting in superior incorporation of the solid particles. Although a process according to this invention may be carried out in the absence of slats, or other pressure distribution control, this could diminish the uniformity of solid particle incorporation.

The pressure drop across the yarn (from the first face to the second face) may be achieved by maintaining a lower pressure at the second face of the yarn than at the first face of the yarn. This pressure drop may be achieved by applying suction to the second face of the yarn.

The air dispersion process of the present invention can operate in a batchwise or continuous mode. In a preferred embodiment, a process of the invention operates continuously and includes continuously feeding the yarn between (1) a supply zone in which the stream of gaseous carrier and the entrained solid particles are supplied directly to the first face of the yarn, and (2) a suction zone for applying suction to the second face of the yarn. The suction zone can be varied to any effective length and width and is positioned adjacent to an exhaust port. The exhaust port provides an outlet to a vacuum pump or other suction device.

In another preferred embodiment, the effective length and width of the suction zone is greater than the effective length and width of the supply zone. This facilitates uniform solid particle incorporation by minimizing the formation of turbulent air flows in the solids incorporation zone. This also prevents unnecessary loss of materials to the external environment. In another preferred embodiment, in the suction zone, a pressure drop is generated in parallel to the yarn, as well as perpendicular to the surface of the yarn.

The present invention can use carrier gases such as nitrogen, carbon dioxide, air, or any other suitable gas. Because of its low cost and availability, the preferred carrier gas is air. Preferably, the carrier gas is substantially free of fibrous material and other impurities. Preferably, carrier gas from the suction zone is recirculated to the supply zone, and any entrained solid particles exiting the suction zone is recovered via a cyclone and resupplied to the supply zone.

When the carrier gas contains oxygen, it is desirable that it contains a predetermined quantity of moisture to prevent build up of static charges, which can cause the solid particulate to flash or ignite. In addition, the quantity of moisture should be low enough to prevent aggregation (e.g., clumping) of the solid particles.

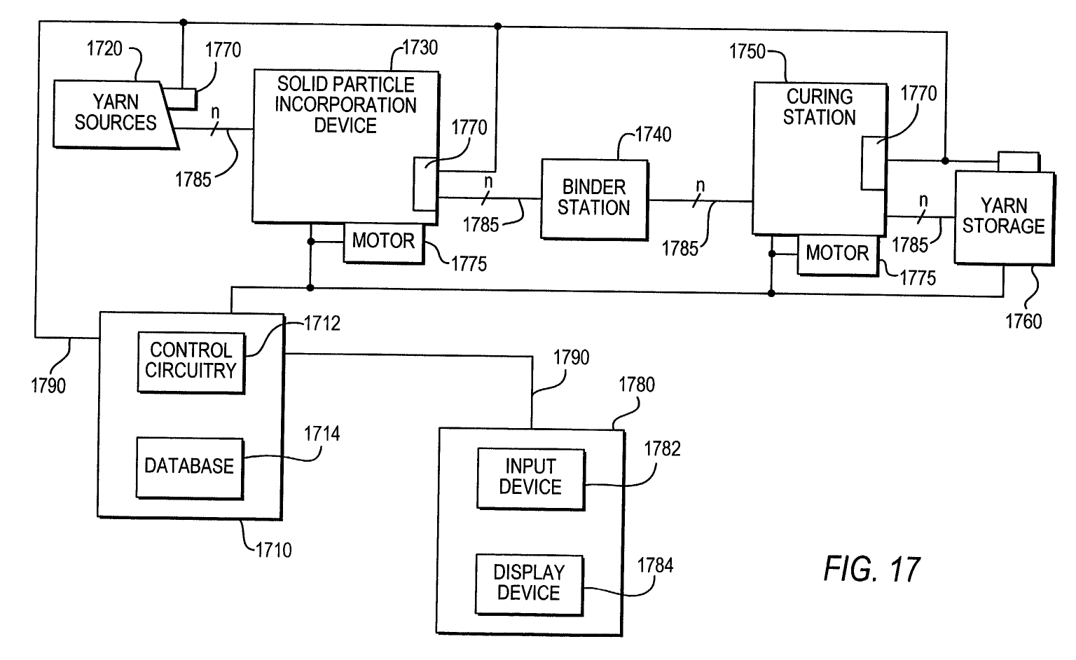

The concentration of solid particles incorporated in the yarn may be dependent on the following parameters: (1) concentration of solid particles in the gaseous carrier stream; (2) rate of flow of gas into the supply zone; (3) rate of flow of gas out of the suction zone; (4) pressure drop between the first and second faces of the yarn; and (5) dwell time (i.e., the time during which the yarn is exposed to the flow of gaseous carrier and entrained solid particles). These parameters can be manipulated in an iterative manner to achieve the desired solid particle loading. (The description accompanying FIG. 17 further describes a system that controls various parameters of the yarn treating process.)

For example, to decrease solid particle incorporation, the solid particle feed level may be decreased, the rate of the gas flow out of the suction zone may be increased, respectively, the pressure drop between the first and second faces may be increased, the dwell time in the incorporation zone may be decreased, or some combination of these steps may be used. Opposite steps could be taken to increase solid particle incorporation.

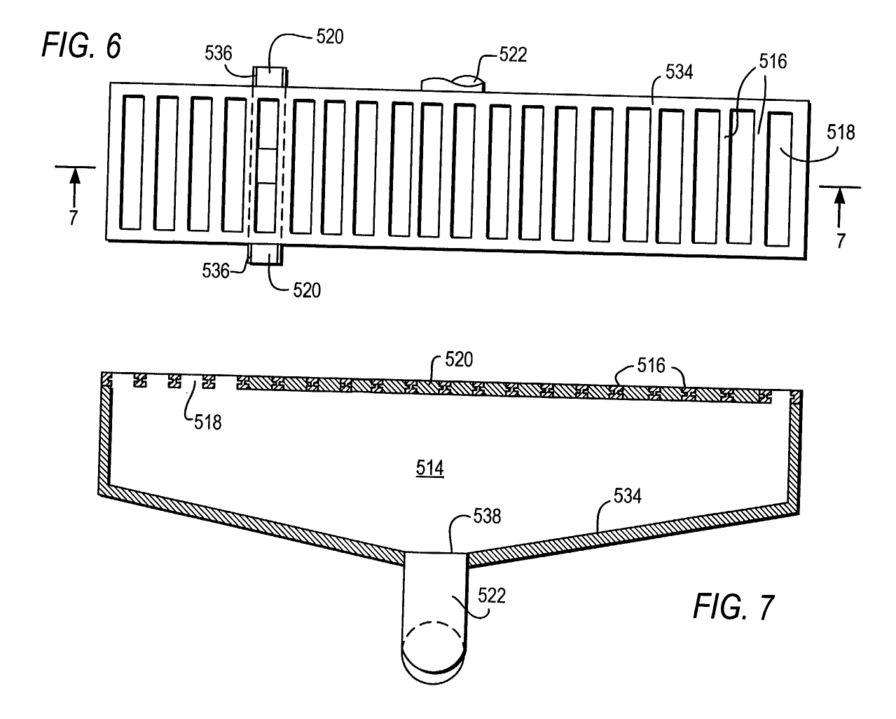

The desired distribution of solid particles across a yarn being treated by the process of this invention can be achieved by adjusting air flow through the incorporation zone (e.g., section of device 500 in which solid particles are deposited into the yarn). For example, using the apparatus of FIGS. 6 and 7, uniformity of particulate solid incorporation may be controlled by adjusting the slats 20. Assume that several yarns are aligned in parallel and are processed using the air dispersion method. If the yarns on the outer portion of the parallel array are not being incorporated with a desired quantity of solid particles, the slats beneath the outer portions of the yarn array may be adjusted to achieve a larger opening, which results in additional gaseous carrier and solid particle flow across the yarn. Conversely, the slats beneath the center portions of the yarn array may be adjusted to achieve a smaller opening, thus decreasing gaseous carrier and solid particle flow at the center of the yarn array.

FIG. 5 shows a cross-sectional view of air dispersion device 500 for incorporating solid particles in accordance with the principles of the present invention. One or more yarns 503 may be supplied to the solids incorporation zone 506 from a yarn source 501. Yarn source 501 can be, for example, a creel having one or more yarn spools for dispensing yarn.

The yarn is fed into solids incorporation zone 506 supported on an air permeable conveyor belt 508. Air permeable conveyor belt 508 may be constructed of wire mesh, a polymer mesh, a fabric, or any other air permeable support structure. Air permeable conveyor belt 508 serves as a support web for the yarn as it passes through solids incorporation zone 506. The air permeability of air permeable conveyor belt 508 assists in controlling the level of solid particle incorporation into the yarn. For example, if belt 508 is highly permeable, then the solid particle deposition will be lower than a belt 508 that has low air permeability.

Air permeable conveyor belt 508 is driven by a motor (not shown). FIG. 5 shows that air permeable conveyor belt 508 travels in a continuous loop over a set of rollers 510 and 512. If desired, a vacuum, brush, air blower, or other device can be used to keep air permeable conveyor belt 508 clean during use.

Yarn 503 can be held in place on the air permeable conveyor belt 508 as it passes through solids incorporation zone 506 through use of suction from below (from the suction zone), picker fingers, pressure from above, or any other means that does not prevent a pressure drop across the yarn 503. The yarn may also be supported by a series of tension rollers as it passes through solids incorporation zone 506. An additional support device may be necessary to provide lateral support to the array of yarns that are passing through device 500. Because a yarn is highly susceptible to air permeability, as opposed to a sheet of material, an additional support may be used to 1) support the yarn to prevent breakage and 2) aid in pressure drop control.

Solid particles are introduced into incorporation zone 506 from an inlet 502. The solid particles may be inserted into the gaseous carrier using, for example, a hammer mill, jet mill or any other suitable device that breaks up and disperses solid particles into an air stream. A blower, fan, pump, pressurized tank or other device can provide pressure such that the gaseous carrier is forced through inlet 502.

Incorporation zone 506 is defined by walls 526 and 528. If desired, incorporation zone 506 may not be pressurized by providing gap 528a in wall 528. Gap 528a provides a vent to the ambient environment, thereby preventing substantial pressurization within device 500. Gap 528a also allows yarn to pass more easily out of incorporation zone 506. A filter unit (not shown) may be coupled to device 500 to prevent solid particles from leaving incorporation zone 506 through gap 528a.

Suction is generated beneath air permeable conveyor belt 508 by using a vacuum, a blower, a fan or any other suitable device. In FIG. 5, suction is generated by drawing air out of outlet pipe 522. Suction box 514 contains airflow controls to evenly distribute the pressure drop across the yarn. Suction box 514 also maintains the yarn in contact with air permeable conveyor belt 508. An even distribution of pressure drop may be achieved using baffles, butterfly valves, sliding barriers, slats, or any other suitable device for varying gas flow.

FIGS. 6 and 7 show more detailed illustrations of the air flow control system of air dispersion device 500. More particularly, FIG. 6 shows a top view of the air flow control system and FIG. 7 shows a cross-sectional view of the air flow control system. As shown in FIGS. 6 and 7, slats 520 are positioned to provide gaps 518, which control the gas flow (i.e., from inlet 502 through outlet pipe 522) and thereby evenly distribute the pressure drop across the yarn. Slats 520 are adjustable such that the size and position of gaps 518 can be varied to obtain the desired gas flow. The number of slats 520 used may depend on the size of air dispersion device 500 and the desired level of gas flow control. Slats 520 have groves 536 that fit into groves 516 and are held by frame 534. Gas flows from suction box 514 through outlet port 522 via opening(s) 538 to outlet pipe 522.

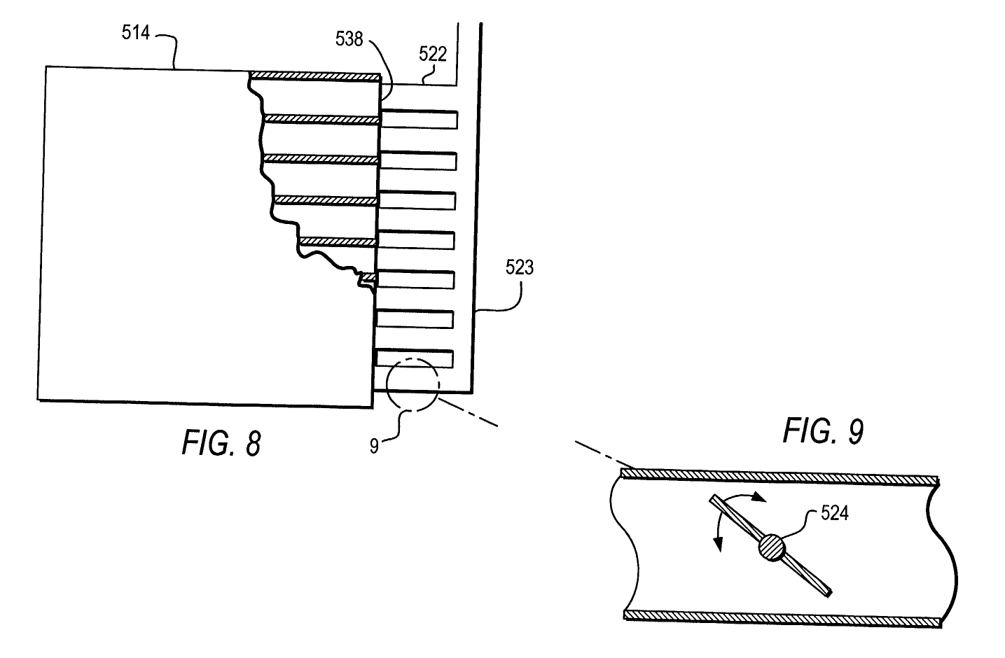

FIG. 8 shows a partial cut away view of suction box 514 coupled to outlet pipe 522 in accordance with the principles of the present invention. FIG. 8 shows a series of openings 538 that are provided to remove air from the suction box 514. Different channels 519 can be opened or closed to provide directional control of the air flow. Directional control is achieved by varying the amount of air passing through outlet port 522 by a series of butterfly valves 524 (shown in FIG. 9) each of which are independently controlled by a series of linkages (not shown).

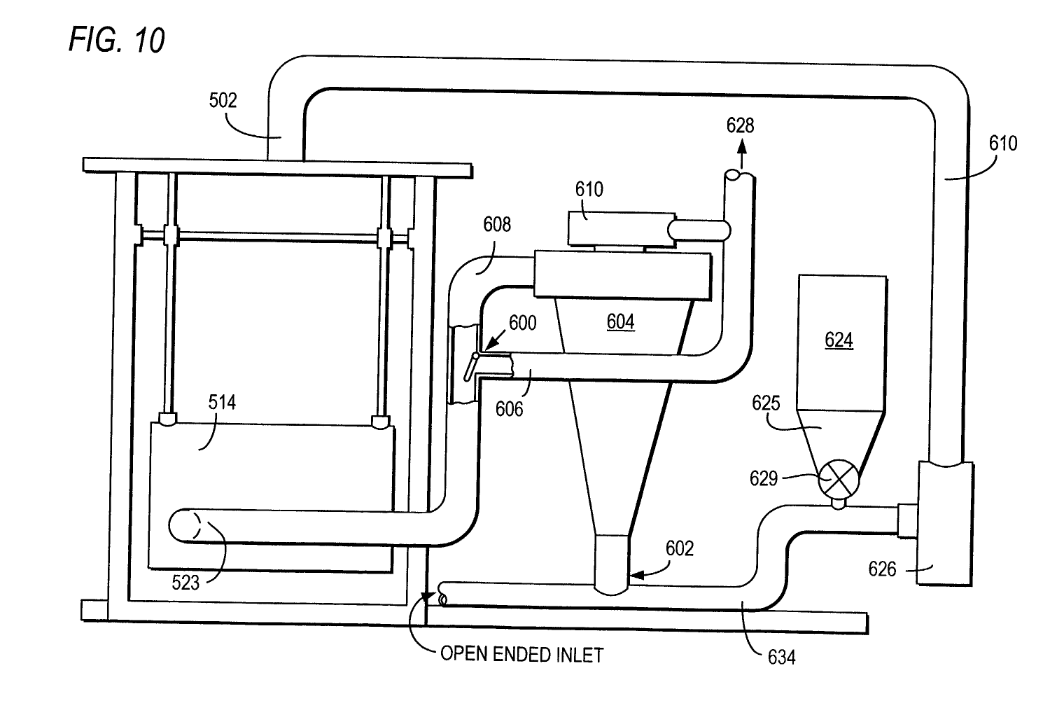

FIG. 10 is an end view of air dispersion device 500 and other devices that are used in conjunction with air dispersion device 500. FIG. 10 shows air dispersion device 500 coupled to inlet port 502 and exhaust manifold 523. Inlet port 502 is connected to fan 626 via line 610. Line 610 can be, for example, a hose, a tube, a pipe (e.g., metal pipe, PVC, etc.), or any other suitable material. Solid particles are fed from hopper 624 by the screw feeder 625 to line 624 via rotary valve 629. The quantity of solid particles injected into the line 634 may depend on the speed in which rotary valve 629 rotates. Rotary valve 629 may, for example, be controlled by a motor to precisely limit the quantity of solid particles deposited into line 634. Fan 626 redirects the solid particles from line 634 to inlet port 502 via line 610.

Carrier gas is drawn from suction box 514 through outlet pipe 522 (not shown) into manifold 523 by fan 628. Carrier gas that still contains entrained solid particles is passed through a cyclone 604 before being vented to atmosphere. Cyclone 604 can extract the solid particles from the carrier gas for re-use. Bypass valve 600 can regulate air flow to line 608 or line 606 depending on solid particle concentration in the carrier gas. For example, carrier gas that is largely devoid of entrained solid particles flows from an upper section 610 of cyclone 604 in accordance with the normal operation of such devices. Solid particles that have been removed from the gas carrier stream by cyclone 604 are fed, via a rotary valve 602 into line 624. Line 624 is an open ended inlet to rotary valve 629 and fan 626. Thus, cyclone 604 can recycle solid particles not incorporated into the yarn passing through air dispersion device 500.

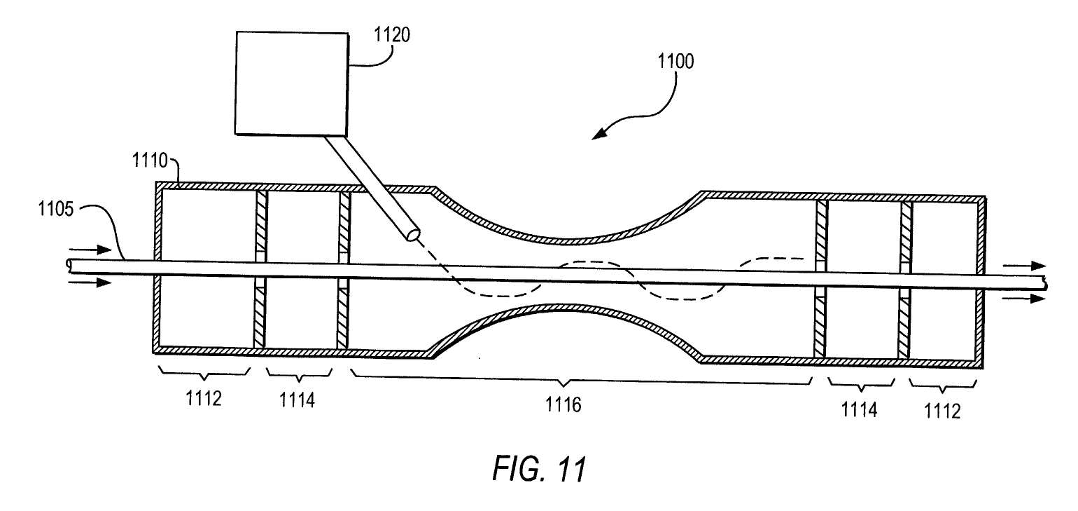

FIG. 11 an alternative air dispersion device that can be used to incorporate solid particles into yarn in accordance with the principles of the present invention. More particularly, FIG. 11 shows a cross-sectional view of air dispersion device 1100. Device 1100 includes a cylindrical tube 1110 having baffled sections 1112 and 1114. In addition, the central portion of cylindrical tube 1110 includes venturi tube 1116. A venturi tube is that restricts flow of a gas or liquid as the gas or liquid passes through a constricted passageway. Yarn 1105 passes through device 1100 along a central axis of tube 1110. Solid particle chamber 1120 injects solid particles (e.g. activated carbon) into venturi tube 1116 at an acute angle to promote swirling of solid particles around yarn 1105. The solid particles may be entrained in a gas such as air or the solid particles may be entrained in a supercritical fluid such as supercritical CO₂.

Different portions of tube 1110 are pressurized at different levels to assist incorporating solid particles into yarn 1105. Baffled section 1112 preferably has less pressure then baffled section 1114. Baffled section 1114 preferably has less pressure then venturi tube 1116. There may be various inlet and outlet ports (not shown) coupled to tube 1110 to provide the varying levels of pressurization. The pressure decreases in baffled sections 1112 and 1114 to prevent the solid particles from spraying out into the ambient environment.

Solid particles are incorporated into yarn 1105 as follows. An entrained solid particle filled gas or liquid passes into venturi tube via insertion member 1120 and begins to swirl around yarn 1105. As the entrained particle gas reaches the constricted portion of venturi tube 1116, the narrow region causes a decrease in pressure that forces the solid particles to “fall” out of the particle stream into yarn 1105. The level of solid particle incorporation can depend on a number of factors such as the speed the yarn as it passes through tube 1110, the concentration of solid particles in the entrained particle stream, and any other suitable factor. Thus it is seen that air dispersion device 1100 can be used to incorporate solid particles into yarn. Persons skilled in the art will appreciate that several air dispersion devices 1100 can be aligned in parallel to treat multiple strands of yarn simultaneously.

The above-described description of the process for incorporating solid particles into the yarn is not intended to be an exhaustive description, but a description that discusses the concept of using such a device to incorporate solid particles in accordance with the principles of the present invention. U.S. Pat. No. 5,709,910, which is hereby incorporated by reference in its entirety, describes a variation of the above-described process with more specificity.

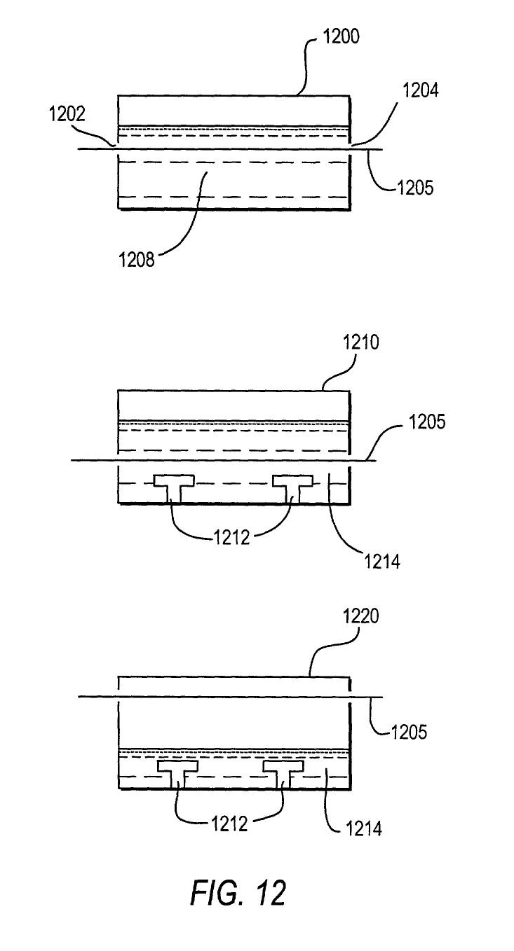

The present invention can use various techniques other than air dispersion to incorporate solid particles into the yarn. For example, yarn can pass through a bath of solid particles. More particularly, yarn can pass through a container such as container 1200 of FIG. 12. Container 1200 is an enclosed device having an inlet port 1202 and outlet port 1204 that provides a pathway for a yarn 1205 to pass therethrough. As shown in FIG. 12, yarn 1205 passes through solid particle bath 1208. As yarn 1205 passes through solid particle bath 1208, a portion of solid particles in container 1200 are incorporated into yarn 1205.

In a different embodiment, container 1210 may be used to ensure a more consistent application of solid particles to yarn 1205 as it passes through container 1210. Container 1210 may include, for example, one or more paddles 1212 that agitate solid particle bath 1214. Paddles 1212 can be any suitable device that is suitable for stirring solid particle bath 1214 such as, for example, propellers, screws, planks, and blenders. If desired, paddles may be controlled by an electromagnetic device that provides a rotating magnetic field that causes paddles 1212 to rotate. Paddles 1212 can be driven by a motor, an engine, or other suitable device. Agitating solid particle bath 1214 prevents yarn 1205 from forming a channel in solid particle bath 1214. If such a channel is formed, then yarn 1205 may or may not be properly coated with solid particles because portions of the yarn may pass through chamber 1210 untouched.

In another embodiment, chamber 1220 may also use paddles 1212 to agitate solid particle bath 1214. In chamber 1220, however, yarn 1205 may not pass directly through solid particle bath 1214. Solid particles are incorporated into yarn 1205 when paddles 1212 stir solid particle bath 1214 at a predetermined rate that causes solid particles to disperse into the airspace surrounding yarn 1205.

Although not shown in containers 1200, 1210, 1220, a solid particle feeder can be coupled to each of the containers to replenish the supply of solid particles. If desired, a rotary screw valve can be used to limit the supply of solid particles provided to containers 1200, 1210 and 1220.

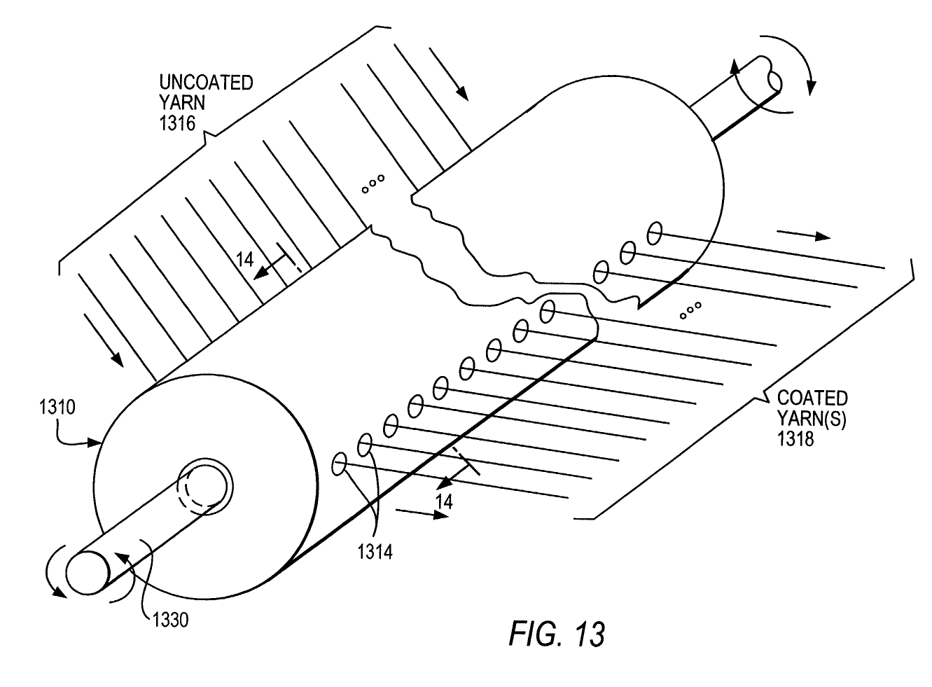

FIG. 13 shows a three-dimensional view of padding device 1300 that may be used to incorporate solid particles into yarn in accordance with the principles of the present invention. Padding device 1300 incorporates solid particles into yarn by passing yarn through a bath of solid particles, agitating the bath of solid particles, and padding solid particles onto the yarn. One advantage of padding device 1300 is that it can continuously process multiple yarns simultaneously. This is especially useful for maximizing the throughput of a yarn treatment process of the present invention. Moreover, padding device 1300 can be easily incorporated into existing yarn treatment facilities. For example, padding device 1300 can be configured to receive yarns provided by a creel.

Padding device 1300 includes container 1310 that has input ports 1312 (not shown) and output ports 1314. A strand of yarn can pass through each input port 1312 and out of its respective output port 1314. Directional arrows are provided in FIG. 13 to illustrate the flow of untreated yarn 1316 through padding device 1300, which exits as coated yarn 1318. Padding device 1300 also includes shaft 1330 that rotates with respect to container 1310. When shaft 1330 rotates, it causes paddles 1340 (not shown) to rotate and stir the solid particles contained within container 1310. Paddles 1340 (not shown) that are positioned along shaft 1330 within container 1310 such that they rotate between the strands of yarn that are passing through container 1310. Shaft 1330 may rotate at any suitable speed and can be driven by an electric motor or engine.

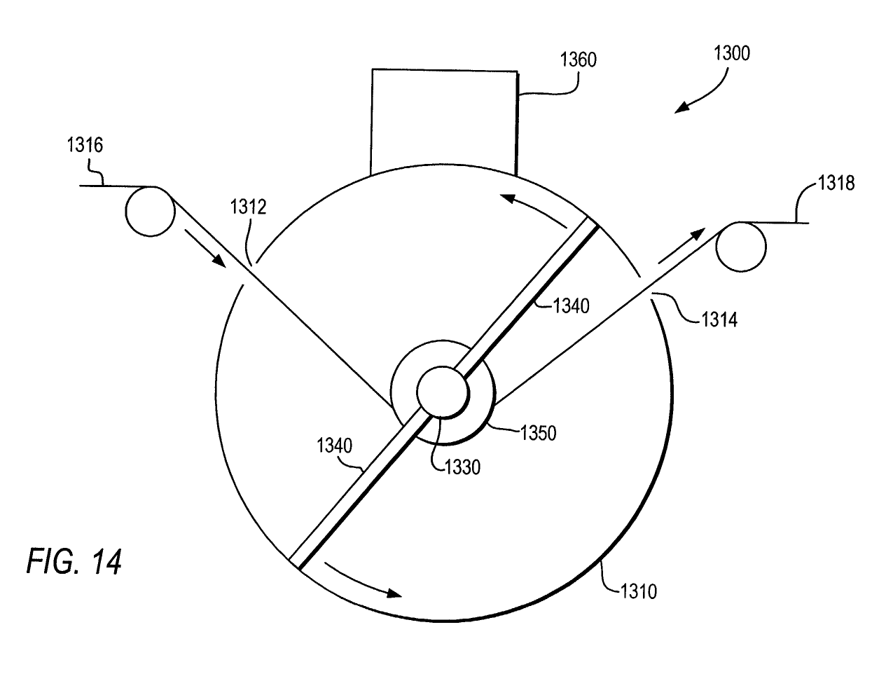

FIG. 14 shows a cross-sectional view of padding device 1300 taken along the lines 14-14 of padding device 1300 in FIG. 13. FIG. 14 shows uncoated yarn 1316 passing through inlet port 1312 to pad 1350 and then exiting through outlet port 1314 as coated yarn 1318. Pad 1350 provides tension support that forces the yarn to travel through the solid particle bath. One advantage of this configuration over the padding chambers shown in FIG. 12 is that the quantity of solid particles (i.e., solid particles not attached to the yarn) exiting the chamber is reduced. This prevents unnecessary pollution of solid particles to the ambient environment.

Even though the yarn passes through a bath of solid particles (not shown), pad 1350 also assists in padding solid particles into the yarn. Pad 1350 provides additional friction that causes the solid particles to attach to the yarn. In addition, pad 1350 also agitates the solid particles to prevent channel formation. Any suitable type material can be used for pad 1350. For example, pad 1350 can be constructed from a soft material such as foam, cotton, or other porous material. Pad 1350 can also be constructed with materials such as plastic, wood, rubber, or steel. Pad 1350 may be further constructed to have a channel that prevents the yarn from slipping off pad 1350 as it passes through device 1300. Such construction can collect or funnel solid particles to the yarn as it rubs against pad 1350.

FIG. 14 also shows paddles 1340 that are attached to shaft 1330. As described above, when shaft 1330 rotates, paddles 1340 rotate to agitate the solid particles. Solid particle hopper 1360 is also shown in FIG. 14, but not in FIG. 13. Solid particles hopper 1360 may distribute controlled quantities of solid particles to container 1310 to ensure that container 1310 is filled with a predetermined volume of solid particles. It is necessary to replenish the supply of solid particles contained within container 1310 because solid particles are constantly being removed from container 1310 via coated yarn 1318.

Using the padding chambers shown in FIG. 12 or padding device 1300, the concentration of solid particle incorporation can depend on a number of different factors. One factor for solid particle incorporation is the type of solid particle used. Different types of solid particles may adhere to the yarn more readily than other types. Another factor that may determine concentration of solid particle incorporation is the speed in which the yarn is passed through the padding device. Therefore, it may be necessary to perform calibration tests to determine the optimal speed that provides the desired level of (solid particle) loading in the yarn.

If desired, any of the solid incorporation devices described above (e.g., air dispersion device and padding device) can apply more than one type of solid particle to the yarn as it is subjected to the solid particle incorporation step. For example, a mixture of activated carbon and binder particles can be incorporated into the yarn simultaneous. The binder particles, when subjected to a curing step, may bind the solid particles to the yarn. Padding device 1300, for example, can be used to mix the different particles to ensure their uniform incorporation into the yarn.

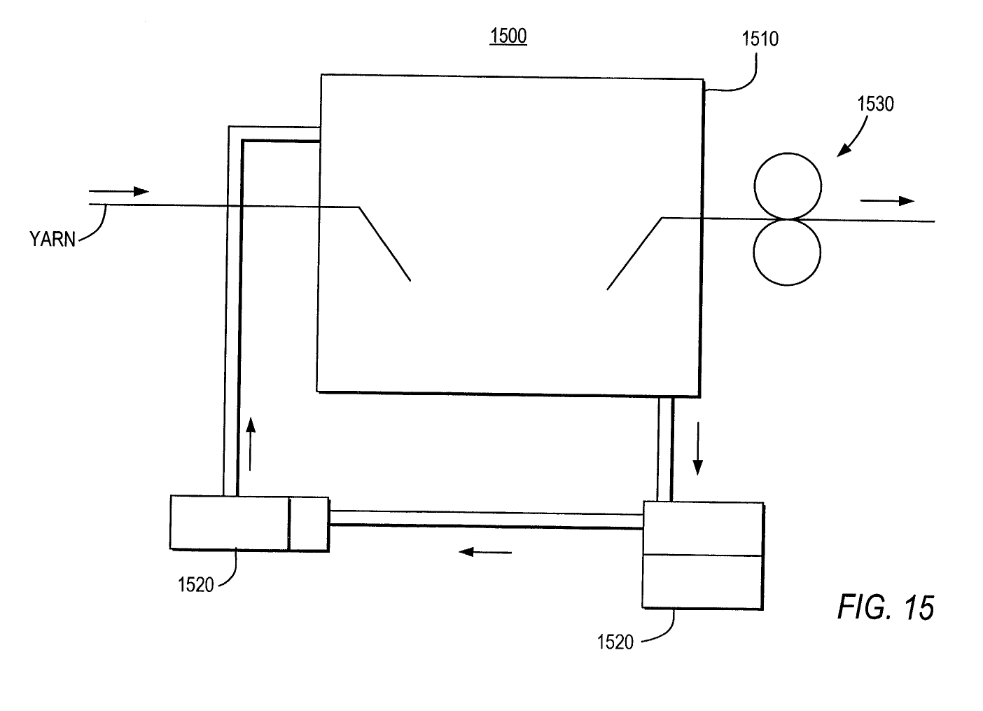

FIG. 15 shows a top view of an illustrative binder application device 1500 that can apply a binding agent to yarn in accordance with the principles of the present invention. Binder application device 1500 can apply a controlled volume of a binding agent or a solution to yarn as it passes through device 1500. Binder application device 1500 includes a solution reservoir 1510, a filter 1520, and squeegee rollers 1530.

Reservoir 1510 may contain a predefined mixture of a binding agent (e.g., resin, glue, epoxy, light activated epoxy, cross-linking polymer, thermoplastic mixture, etc.) and water or other solvent. As the yarn passes through the reservoir, the yarn wicks up the solution (containing the binding agent) and passes it to the next step of the yarn treating process. If desired, different applications can be implemented to apply the solution to the yarn. For example, rollers may be used to apply solution to the yarn. The rollers may “pick up” solution and apply it to the yarn as it passes through reservoir 1510. Such a technique may be desirable so that the yarn is not fully submersed into a solution.

In another suitable approach, the binder solution can be sprayed on to the yarn using, for example, jet heads or sprayers. Using this approach, the yarn may pass through a chamber that provides a mist or steady stream of solution to the yarn.

Filter 1520 can be coupled to reservoir 1510 to filter out any solid particles that are deposited into reservoir 1510 as coated yarn passes through device 1500. Filter 1520 prevents free-floating solid particles from clogging the inlet and outlet ports of reservoir 1510. Moreover, filter 1520 ensures that the solution applied to the yarn is substantially consistent and free of coagulants. It should be noted, however, that filter 1520 may not be needed if the yarn is coated with solid particles after the binder is applied to the yarn (as described in process 300 of FIG. 3).

When yarn is immersed in a solution bath, for example, a surplus of solution may be attached to the yarn. Therefore, squeegee rollers 1530 may be used to squeeze excess solution (e.g., binding agent) off the yarn. In another suitable approach, a vacuum may be applied to pull excess solution off the yarn after it has been subjected to the binder application step.

As described above, a curing step is employed to cure, fix, or set a binding agent that has been applied to the yarn. When the binding agent cures, the solid particles are permanently attached to the yarn. Curing the binding agent can be accomplished by subjecting coated yarn to various conditions such as, for example, heat, light, irradiation, air, or any combination thereof. If desired, coated yarn can be subjected to cool temperatures to effect curing for certain binding agents. The present invention may use any suitable device to provide the above-mentioned conditions. For example, the coated yarn can pass through an irradiation oven that subjects the yarn to radiation, (e.g., infrared radiation, ultra-violet radiation, or any other suitable radiation). In another example, an oven (e.g., a hot air convention oven or an electric oven) may be used to subject the coated yarn to heat. In a further example, the treated yarn may be subjected to heated drums that heat and cure the binding agent applied to the yarn. In yet a further example, a fan or multiple fans may be used to blow air over the yarn to affect curing.

The present invention can use several curing devices in combination. For example, the coated yarn may first pass through an irradiation oven and then be subjected to heated drums. The physical size of the curing devices may depend on the type of yarn, solid particles, and/or binding agent used to treat the yarn. In addition, the speed (e.g. rate) at which curing can be performed may depend on the yarn, solid particles, and/or binding agent used. If desired, the path in which the yarn passes through a curing device may be configured to comply with various demands of the yarn treating process. One such demand is to maximize the throughput of treated yarn.

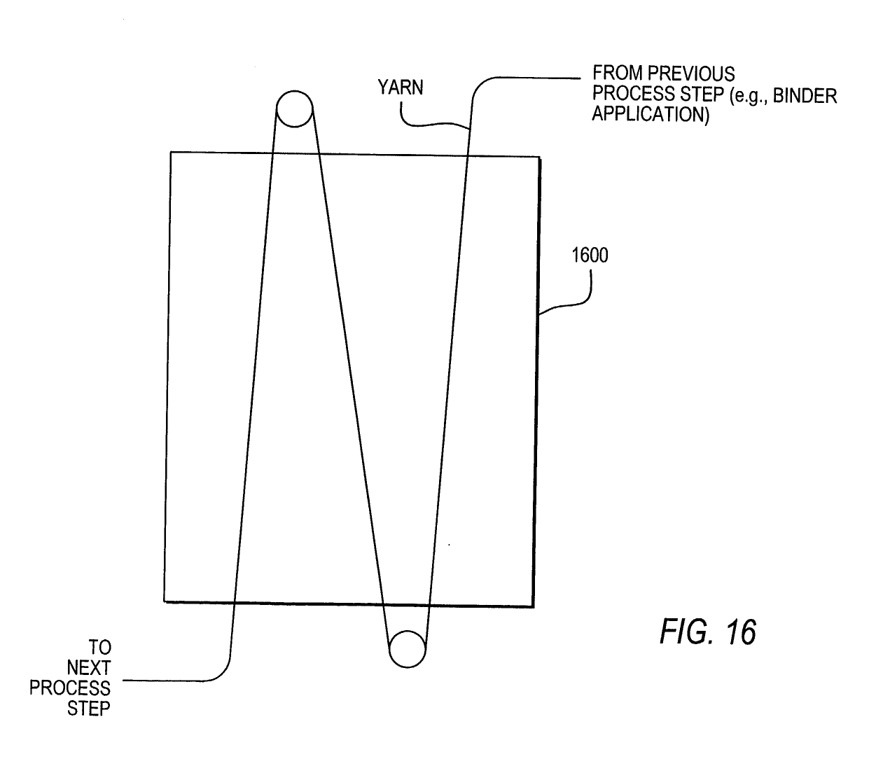

To maximize the throughput of treated yarn, it is desirable to minimize the time necessary for each stage of the process to complete its respective task. If the curing step requires more time to cure the binding agent than the time required for incorporating the solid particles or applying a binding agent, then the yarn may pass through the curing device several times to obtain sufficient curing without slowing down the overall yarn treating process. FIG. 16 shows an illustrative yarn flow path through curing device 1600. Shown in FIG. 16, the yarn passes through curing device 1600 multiple times. By passing the yarn through curing device 1600 several times, the binding agent has sufficient time to cure while not slowing down the other steps of the process.

The yarn treatment processes of the present invention can be performed in accordance with the present invention using illustrative yarn treatment system 1700 shown in FIG. 17. Yarn treatment system 1700 may include computer 1710, yarn sources 1720, solid particle incorporation station 1730, binder station 1740, curing station 1750, yarn storing station 1760, sensors 1770, motors 1775, and user interface equipment 1780. Yarn treatment system 1700 may include a transporting system (e.g., conveyor belt) (not shown) that is driven, for example, by motors 1775. The transportation system may transport yarn array 1785 from station to station at a controllable rate. FIG. 17 shows that yarn array 1785 is delineated by the letter n, which represents that yarn array 1785 can include any suitable number of yarns as supplied by yarn sources 1720. As shown, yarn array 1785 is shown being transported to solid particle incorporation station 1730, binder station 1740, curing station 1750, and receiving station 1760 via the transportation system.

Computer 1710 is illustrated to be connected to solid particle incorporation device 1730, curing station 1750, sensors 1770, motors 1775, and user interface equipment 1780 via communication paths 1790. It should be noted that the above-mentioned connections are illustrative and that additional or different combinations of communications path 1790 interconnections to computer 1710 can be implemented. For example, a communications path 1790 can be provided between computer 1710 and binder station 1740.

Persons skilled in the art will appreciate that yarn treatment system 1700 can be configured in a different arrangement than that shown in FIG. 17. For example, yarn array 1785 may pass through binder station 1740 before passing through solid particle incorporation station 1730. Moreover, persons skilled in the art will appreciate that binder station 1740 is optional and may not be included as part of yarn treating system 1700.

Computer 1710 controls a process such as process 200, process 300, process 400 as discussed above in conjunction with FIGS. 2, 3, and 4, respectively. Computer 1710 may include electronic circuitry 1712 (e.g., hard-drive, processor, memory, communications buses, etc.) that handles transmission of data to, from, and/or between solid particle incorporation device 1730, curing station 1750, sensors 1770, motors 1775, and user interface equipment 1780, or any other suitable equipment. Electronic circuitry 112 may enable computer 1710 to perform yarn treating processes by controlling, for example, solid particle incorporation station 1730, curing station 1750, sensor 1770, and motors 1775. Electronic circuitry 112 may control motors 1775 to dictate the speed in which yarn array 1785 is transported through yarn treating system 1700.

If solid particle incorporation station 1730 is air dispersion device 500 (of FIG. 5), then electronic circuitry 1712 may control, for example, the air dispersion of solid particles by adjusting planks 520 (FIGS. 6 and 7) and butterfly valves 524 (FIG. 9). If solid particle incorporation station 1730 is padding device 1300 (of FIG. 13), electronic circuitry 1712 may control, for example, a motor that rotates shaft 1330. Rotating shaft 1330 agitates the solid particles contained within container 1310.

If curing station 1750 is an oven, then electronic circuitry 1712 may control the oven's temperature. Electronic circuitry 1712 may control the application of irradiation such as infrared radiation, if curing station 1750 is an irradiation oven.

Electronic circuitry 1712 can also monitor data obtained from sensors 1770. Sensors 1770 can monitor yarn array 1785 for breakage and alert computer 1710 that one of the yarn strands is not being properly processed in yarn treating system 1700. Certain sensors 1770 may provide data that indicates whether a particular station is adequately performing its intended function. For example, one of the sensors 1770 coupled to curing station 1750 may provide information as to whether the binding agent is fully cured after exiting the curing step. If, for example, the binding agent is not fully cured after yarn array 1785 is subjected to the curing step, electronic circuitry 1712 may cause yarn treating system 1700 to slow down the processing speed (i.e., to provide adequate time for the binding agent to cure). Other sensors 1770 may be used to monitor the level of solid particles contained in solid particle incorporation station. Sensors 1770 may be used to monitor the loadings of solid particles in the yarn.

Electronic circuitry 1712 may store, retrieve, and distribute information from database 1714. Database 1714 stores information that enables a yarn treating process to be performed with yarn treating system 1700. For example, database 1714 may store yarn treating profiles for particular types of yarn, binding agent, curing mechanisms, etc. Database 1714 can store software programs that assist control and operation of a yarn treating process. Software programs may be used to automate portions of the yarn process. For example, software may automate control of the transportation system. In another example, the software may analyze the information obtained by sensors 1770.

Computer 1710 may initiate processes by responding to user input from user interface equipment 1780. Computer 1710 may also provide information to a user at user interface equipment 1780 by providing data acquired during operation of the yarn treating process. User interface equipment 180 enables a user to input commands to computer 1780 via input device 1782. Input device 1782 may be any suitable device such as, for example, a conventional keyboard, a wireless keyboard, a mouse, a touch pad, a trackball, a voice activated console, or any combination of such devices. Input device 1782 may enable a user to enter commands to perform a particular yarn treating process. If desired, input device 1782 may enable a user to control solid particle incorporation into yarn array 1785 of solid particle incorporation station 1730. A user may monitor yarn treating processes operating on yarn treating system 1700 on display device 1784. Display device 1784 may be a computer monitor, a television, a flat panel display, a liquid crystal display, a cathode-ray tube (CRT), or any other suitable display device.

Communication paths 1790 may be any suitable communications path such as, for example, a cable link, a hard-wired link, a fiber-optic link, an infrared link, a ribbon-wire link, a blue-tooth link, an analog communications link, a wireless link, a digital communications link, or any combination of such links.

Using the above-mentioned yarn treating processes and yarn treating system, various materials, fabrics, and other yarn-based objects can be constructed with the treated yarn. For example, the treated yarn can be used to weave a garment such as a sock. Such a sock can adsorb unpleasant odors that may emanate from a person's foot. Persons skilled in the art will appreciate that garments (e.g., sock) can be constructed in part with treated yarn and untreated yarn. A sock, for example, may be constructed using treated yarn for the bottom portion of the sock, while the other portion of the sock is constructed using an untreated yarn.

The treated yarn of the present invention can be used in other applications such as, for example, upholstery, carpeting, rugs, mats, linins, sheets, towels, rags, pet beds, mattress pads, mattresses, home furnishings, curtains, furnace filters, shoes, insoles, and diapers. The treated yarn can also be used in clothing such as shirts, pants, blouses, undergarments (e.g., t-shirts, underwear, bras, etc.), hats, and other clothing related items. Protective suits such as biochemical protective suits, and anti-irradiation suits (i.e., suits that provides protection against infrared radiation) can be constructed using the treated yarn. In addition, hunting gear can be constructed using the treated yarn of the present invention. Moreover, filters can be constructed with the treated yarn. Such filters can be used in vacuum cleaners to trap pollen and other particles. The treated yarn filters can be used in laboratories using hazardous biological materials; the solid particles in the yarn may entrap the biological agents and prevent them from escaping into the atmosphere.

Persons skilled in the art will appreciate that the above-mentioned applications for the treated yarn of the present invention is not an exhaustive list, but merely an exemplary description of the possible applications.

The following example provides illustrative examples on how the present invention can be used to obtain yarn having solid particles embedded therein using the methods described above. This example is for the purpose of illustration only and is not to be construed as limiting the scope of the invention in any way.

### EXAMPLE 1

This example was performed using process 200 of FIG. 2 as described above. The yarn used for the yarn treating process was 100% cotton yarn sold by National Spinning Company of Greenville, N.C. Solid particles were incorporated into the cotton yarn using a padding device such as padding device 1300 of FIGS. 13 and 14. The solid particles contained within the padding device were activated carbon particles sold as SA-30 by the CarboChem Corporation, of Ardmore, Pa. While the yarn passed through the padding device, paddles 1340 agitated the solid particle mixture. This agitation prevented the yarn from forming channels in the padding device. If channels form, the solid particles may not adequately coat the yarn. A padding roller within the padding device also padded the solid particles onto the yarn as it passed through the device.

After the yarn is coated with activated carbon it was passed through a binding station like binder application device 1500 of FIG. 15. The binder station applied a binding agent to the treated yarn using a padded roller. The binding agent was included in a solution to facilitate its application. The solution included the binding agent sold as Hipochem TF-3500 by High Point Chemicals Corporation, of High Point, N.C. The solution also included moisture management agent sold as Sil-Fin HFS by High Point Chemicals Corporation, of High Point, N.C. Both the Hipochem binder and the HFS agent were mixed together with water to form a solution. The binders comprised 10% by weight in water of the solution.

The treated yarn was then passed through an infrared oven with a dwell time of 60 seconds. The IR emitters of the oven were set to a temperature of 550° C. as measured on the emitters. In addition, the yarn passed through the oven at distance of about seven inches below the emitter surface.

The treated yarn was knit into a tube sock to measure the carbon activity. The carbon activity was measured using the ASTM D 5742-95 method. The ASTM method saturates the yarn sample with butane gas, then measures the saturated yarn to determine mass pick up. The device determined that 19 g/m² of active carbon was on the treated yarn.

Thus it is seen that processes for treating yarn by incorporating solid particles therein to enhance the performance characteristics of the yarn while preserving the physical properties of the yarn are provided. A person skilled in the art will appreciate that the present invention can be practiced by other than the described embodiments, which are presented for purposes of illustration rather than of limitation, and the present invention is limited only by the claims which follow.

What is claimed is:

1. A method for treating a porous yarn, the method comprising:
depositing a plurality of solid particles into the porous yarn; and
permanently binding the plurality of solid particles to the porous yarn such that the plurality of solid particles enhance the performance characteristics of the porous yarn.

2. The method of claim 1 further comprising:
applying a binding agent to the porous yarn; and
curing the binding agent to permanently fix the plurality of solid particles to the porous yarn.

3. The method of claim 2, wherein said curing comprises applying heat to the porous yarn, irradiating the porous yarn, or blowing air over the porous yarn.

4. The method of claim 2 further comprising removing an excess of the binding agent.

5. The method of claim 2, wherein the binding agent is selected from the group consisting of resin, glue, epoxy, tar, cross-linking polymer, thermoplastic polymer, siloxane based reactive polymer, polyurethane, polyacrylic, natural rubber latex, NEOPRENE, styrene butadiene, acrylic/acrylonitrile copolymer, modified n-butyl acrylonitrile copolymer, acrylonitrile polyvinyl acetate, polyacrylate, acrylonitrile butadiene, acrylic methyl methacrylate, self cross-linking copolymers of vinyl acetate, self cross-linking copolymers of ethylene, polystyrenes, polyesters, polyvinyl alcohol, polyvinyl acetate, vinyl chloride copolymers, melamine-formaldehyde resins, solutions of starch, carboxymethyl cellulose, methyl cellulose, sodium silicate, and siloxanes, including functionalized siloxanes, and any combination thereof.

6. The method of claim 1, wherein the plurality of solid particles are deposited as substantially dry solid particulates.

7. The method of claim 1, wherein the binding agent is diluted in a solution or foam that is applied to the porous yarn.

8. The method of claim 1, wherein said depositing comprises:
entraining the plurality of solid particles in a gas; and
maintaining a pressure drop across the porous yarn, thereby to incorporate at least some of the entrained solid particles in the gas into the porous yarn.

9. The method of claim 1, wherein said depositing comprises:
passing the porous yarn through a chamber containing the plurality of solid particles; and
mixing the plurality of solid particles to provide a substantially constant flow of the plurality of solid particles over the porous yarn.

10. The method of claim 1, wherein said depositing comprises passing the porous yarn through a bath of the plurality of solid particles.

11. The method of claim 1, wherein said depositing comprises padding the plurality of solid particles onto the porous yarn.

12. The method of claim 11, wherein the plurality of solid particles are padded onto the porous yarn with at least one roller.

13. The method of claim 1 further comprising:
spooling said porous yarn from a first spool;
spooling a second porous yarn from a second spool; and
arraying said porous yarn and said second porous yarn in a predetermined configuration prior to said depositing.

14. The method of claim 1 further comprising winding said porous yarn onto a spool after said binding.

15. The method of claim 1, wherein the performance characteristics are selected from the group consisting of odor-adsorption, moisture management, ultraviolet light protection, thermal insulation, thermal regulation, antiviral protection, antibacterial protection, antifungal protection, antimicrobial protection, fire protection, chemical agent protection, infrared light protection, and any combination thereof.

16. The method of claim 1, wherein said plurality of solid particles are selected from the group consisting of activated carbon, graphite, silica gel, activated alumina, aluminum trihydrate, pot ash, baking soda, paramethoxy 2-ethoxyethylester cinnamic acid, zinc oxide, zealites, titanium dioxide, and any combination thereof.

17. The method of claim 1, wherein said depositing comprises:
passing the porous yarn through a pressurized tube having a constricted passageway; and
injecting a carrier substance comprising the plurality of solid particles through a member interconnected with the pressurized tube, wherein the plurality of solid particles are deposited into the porous yarn when the carrier substance passes through the constricted passageway.

18. The method of claim 17, wherein the constricted passageway provides a pressure drop that forces a portion of the plurality of solid particles in the carrier substance to drop out of the carrier substance.

19. The method of claim 17, wherein the carrier substances is a gas or a super-critical fluid.

20. The method of claim of 17, wherein the carrier substance swirls around the porous yarn to promote incorporation of the plurality of solid particles.

21. A fabric comprising a porous yarn having a plurality of solid particles embedded therein according to claim 1.

22. The fabric according to claim 21, wherein the fabric is a non-woven fabric, a woven fabric, or a knitted fabric.

23. A garment comprising a porous yarn having a plurality of solid particles embedded therein according to claim 1.

24. An air dispersion method for treating porous yarn, the method comprising:
entraining a plurality of solid particles in a carrier substance;
dispersing the entrained solid particles in the carrier substance over the porous yarn;
maintaining a pressure drop across the porous yarn, thereby to incorporate at least some of the entrained solid particles in the carrier substance into the porous yarn; and
binding the plurality of solid particles to the porous yarn.

25. The method of claim 24, wherein the maintaining comprises controlling the pressure drop to control the dispersion of the plurality of solid particles.

26. The method of claim 24, wherein said binding comprises:
applying a solution comprising at least a binding agent to the porous yarn; and
curing the binding agent such that the plurality of solid particles are permanently attached to the porous yarn.

27. The method of claim 24, wherein said binding comprises binding the plurality of solid particles to the porous yarn without deactivating the plurality of solid particles.

28. The method of claim 24, wherein the carrier substance is a gas or a liquid.

29. A method for treating at least one porous yarn, the method comprising:
passing said at least one porous yarn along at least one path;
padding said at least one porous yarn with a plurality of solid particles as said at least one porous yarn passes along said at least one path; and
binding said plurality of solid particles to said at least one porous yarn.

30. The method of claim 29, wherein said binding comprises:
applying a solution comprising at least a binding agent to said at least one porous yarn; and
curing the binding agent such that the plurality of solid particles are permanently attached to said at least one porous yarn.

31. The method of claim 29, wherein said binding comprises binding the plurality of solid particles to said at least one porous yarn without inhibiting the performance characteristics associated with the plurality of solid particles.

32. The method of claim 29 further comprising mixing the plurality of solid particles.

33. The method of claim 29, wherein said padding comprises passing said at least one porous yarn through a bath of the plurality of solid particles.

34. A system for treating a porous yarn, the system comprising:
a solid particle incorporation chamber that disposes a plurality of solid particles into the porous yarn;
a curing station that permanently attaches the plurality of solid particles to the porous yarn; and
control circuitry that controls the rate in which the porous yarn passes through the solid particle incorporation chamber and the curing station.

35. The system of claim 34 further comprising a binding agent application station that applies a solution to the porous yarn, the solution comprising at least a binding agent.

36. The system of claim 35, wherein the curing station cures the binding agent, wherein said cured binding agent permanently attaches the plurality of solid particles to the porous yarn.

37. The system of claim 35, wherein the control circuitry controls the rate in which the porous yarn passes through the binding agent application station.

38. The system of claim 34, wherein the curing station comprises an irradiation oven that irradiates the porous yarn.

39. The system of claim 34, wherein the curing station comprises a convection oven that heats the porous yarn.

40. The system of claim 34, wherein the curing station comprises an air blower that blows air across the porous yarn.

41. The system of claim 34, wherein the binding agent is selected from the group consisting of resin, glue, epoxy, tar, cross-linking polymer, thermoplastic polymer, siloxane based reactive polymer, polyurethane, polyacrylic, natural rubber latex, NEOPRENE, styrene butadiene, acrylic/acrylonitrile copolymer, modified n-butyl acrylonitrile copolymer, acrylonitrile polyvinyl acetate, polyacrylate, acrylonitrile butadiene, acrylic methyl methacrylate, self cross-linking copolymers of vinyl acetate, self cross-linking copolymers of ethylene, polystyrenes, polyesters, polyvinyl alcohol, polyvinyl acetate, vinyl chloride copolymers, melamine-formaldehyde resins, solutions of starch, carboxymethyl cellulose, methyl cellulose, sodium silicate, and siloxanes, including functionalized siloxanes, and any combination thereof.

42. The system of claim 34, wherein the solid particle incorporation chamber comprises a bath of the plurality of solid particles.

43. The system of claim 42, wherein the solid particle incorporation chamber comprises at least one paddle that stirs said bath to promote deposition of the plurality of solid particles onto the porous yarn.

44. The system of claim 34, wherein the particle incorporation chamber comprises an airflow system that disperses the plurality of solid particles over the porous yarn by maintaining a pressure drop over the porous yarn.

45. The system of claim 44, wherein the airflow system comprises at least one slat that controls the dispersion of the solid particles over the porous yarn.

46. The system of claim 44, wherein the airflow system is configured to:
collect the plurality of solid particles not retained by the porous yarn; and
re-disperse the collected plurality of solid particles.

47. The system of claim 34, wherein the solid particle incorporation chamber comprises:
a pressurized tube having a constricted passageway therethrough, the pressurized tube constructed to allow the porous yarn to pass therethrough; and
a member interconnected with the pressurized tube that injects a carrier substance comprising the plurality of solid particles, wherein the plurality of solid particles are deposited into the porous yarn when the carrier substance passes through the constricted passageway.

48. The system of claim 47, wherein the constricted passageway provides a pressure drop that forces a portion of the plurality of solid particles in the carrier substance to drop out of the carrier substance.

49. The system of claim 47, wherein the carrier substance is a gas or a super-critical fluid.

50. The system of claim 47, wherein the member is coupled to the pressurized vessel at a predetermined angle to enable the carrier substance to swirl around the porous yarn.

51. The system of claim 35, wherein the binding agent application station comprises a bath of the solution.

52. The system of claim 35, wherein the binding agent application station comprises at least one roller that removes an excess of the solution from the porous yarn.

53. The system of claim 35, wherein the binding application station comprises a filtering system that removes the plurality of solid particles collected in the binding application station.

54. The system of claim 35, wherein the binding application station comprises:
at least one reservoir that contains the solution; and
at least one roller coupled to receive the solution from said at least one reservoir, said at least one roller applies the solution to the porous yarn.

55. The system of claim 34 further comprising a creel having at least one spool of the porous yarn.

56. The system of claim 34 further comprising a slasher that arrays said at least one spool of the porous yarn in a predetermined configuration.

57. The system of claim 34 further comprising a winder having at least one spool that winds the porous yarn after the treating process.

58. The system of claim 34, wherein the plurality of solid particles are selected from the group consisting of activated carbon, graphite, silica gel, activated alumina, aluminum trihydrate, pot ash, baking soda, paramethoxy 2-ethoxyethylester cinnamic acid, zinc oxide, titanium dioxide, and any combination thereof.

59. The system of claim 34, wherein the plurality of solid particles impart performance enhancing characteristics to the porous yarn, the performance enhancing characteristics are selected from the group consisting of odor-adsorption, moisture management, ultraviolet light protection, thermal insulation, thermal regulation, antiviral protection, antibacterial protection, antifungal protection, antimicrobial protection, fire protection, chemical agent protection, infrared light protection, and any combination thereof.

60. The system of claim 34, wherein the control circuitry detects breakage of a strand of the porous yarn.

61. A treated yarn, comprising:
a yarn having a porous structure;
a plurality of activated solid particles;
a binding agent that permanently attaches the plurality of activated solid particles to the porous structure such that the plurality of activated solid particles are in direct contact with the porous yarn and the ambient environment.

62. The treated yarn of claim 61, wherein the plurality of activated solid particles uniformly coat the porous yarn.

63. The treated yarn of claim 61, wherein the plurality of solid particles are selected from the group consisting of activated carbon, graphite, silica gel, activated alumina, aluminum trihydrate, pot ash, baking soda, paramethoxy 2-ethoxyethylester cinnamic acid, zinc oxide, titanium dioxide, or any combination thereof.

64. The treated yarn of claim 61, wherein the plurality of solid particles impart performance enhancing characteristics to the porous yarn, the performance enhancing characteristics are selected from the group consisting of odor-adsorption, moisture management, ultraviolet light protection, thermal insulation, thermal regulation, antiviral protection, antibacterial protection, antifungal protection, antimicrobial protection, fire protection, chemical agent protection, infrared light protection, and any combination thereof.

65. A fabric formed from the treated yarn according to claim 61.

66. The fabric according to claim 65, wherein the fabric is a non-woven fabric, a woven fabric, or a knitted fabric.

67. A garment formed from the treated yarn according to claim 61.

68. A treated yarn, comprising:
a yarn constructed from fibers; and
a plurality of activated solid particles that are permanently fused to the fibers, wherein the yarn is fused to at least a portion of each activated solid particle such that the remaining portion of each activated solid particle is exposed to the ambient environment.

69. The treated yarn of claim 68 further comprising a chemical bond that fuses the plurality of activated solid particles to the yarn.

70. A method for treating a yarn, the method comprising:
depositing a plurality of solid particles into the yarn, wherein said plurality of solid particles are not part of a solution; and
permanently binding the plurality of solid particles to the yarn such that the plurality of solid particles enhance the performance characteristics of the yarn.
